(19) United States
(12) Patent Application Publication
(10) Pub. No.: US 2012/0019441 A1
(43) Pub. Date: Jan. 26, 2012

(54) MOBILE ELECTRONIC DEVICE

(75) Inventors: Yasuhiro Ueno, Kanagawa (JP); Seiji Horii, Kanagawa (JP); Tomoko Asano, Kanagawa (JP)

(73) Assignee: KYOCERA CORPORATION, Kyoto (JP)

(21) Appl. No.: 13/260,536

(22) PCT Filed: Mar. 25, 2010
(86) PCT No.: PCT/JP2010/055278

§ 371 Date: Sep. 26, 2011

(30) Foreign Application Priority Data
Mar. 26, 2009 (JP) 2009-077784

(51) Int. Cl. G09G 5/00

(52) U.S. Cl. 345/156

(57) ABSTRACT

It is an object to provide a mobile electronic device capable of projecting a more serviceable and useful image. The mobile electronic device includes an operating unit, an image projector that projects an image toward a target object, and a control unit that controls at least an operation of the image projector based on an input to the operating unit. The mobile electronic device is configured that when information about the number of divisions of the target object is input from the operating unit, the control unit causes the image projector to project an image used to divide the target object into the number of divisions, and the task is thereby solved.

### CROSS-REFERENCE TO RELATED APPLICATION

This application is a National Stage of PCT international application Ser. No. PCT/JP2010/055278 filed on Mar. 25, 2010 which designates the United States, incorporated herein by reference, and which is based upon and claims the benefit of priority from Japanese Patent Application No. 2009-077784, filed on Mar. 26, 2009, the entire contents of which are incorporated herein by reference.

### TECHNICAL FIELD

The present invention relates to a mobile electronic device. Background

### BACKGROUND ART

As a conventional device for projecting an image to a wall surface or a screen, a so-called projector is used. A mainstream of the projector is a so-called stationary type device which is supplied with power from a commercial power supply and is used when it is fixed to a predetermined location. A projector as the stationary type projects, in its fixed state, an image to a given portion of the wall surface or to the screen.

Recently, on the other hand, a mobile projector compact in size and easy to carry is proposed as the projector. For example, Patent Literature 1 describes a mobile terminal with a projector function which incorporates a projector that includes an upper housing, a lower housing, and a hinge portion for mutually pivotally connecting the upper housing and the lower housing and that has a lens and a light source.

### CITATION LIST

### Patent Literature

Patent Literature 1: Japanese Patent Application Laid-open No. 2007-96542

### DISCLOSURE OF INVENTION

### Problem to be Solved by the Invention

The mobile projector as described in Patent Literature 1 has advantages such that it can be carried and a position irradiated with an image can be easily adjusted manually, unlike the stationary type projector that is assumed to project an image to a certain position continuously. In this manner, the mobile projector has the advantages that an image can be projected to an arbitrary position. However, both an irradiated plane to which an image is projected and the projector are located in arbitrary positions, and thus the size of the image projected to the irradiated plane changes depending on use conditions.

In recent years, of mobile electronic devices, some mobile phones or the like provided with a communication function enable users to access mail-order service and Internet auction. In the mail-order service and Internet auction, photos or the like of actual goods are recorded as images. However, because a liquid-crystal screen provided in the mobile electronic device is small in size, its size for display has a limit. Therefore, the users are difficult to imagine actual goods even if they view images on the liquid-crystal screen. In this case, if a projector is used to display the images, the images can be displayed on a large screen. However, the size of an image projected from the projector changes depending on conditions, and therefore it is difficult for the user to imagine a real one from the displayed image.

It is an object to provide a mobile electronic device capable of displaying a more serviceable and useful image.

### SUMMARY OF THE INVENTION

According to an aspect of the present invention, mobile electronic device includes: an operating unit; an image projector that projects an image toward a target object; and a control unit that controls operations of the units. When information about the number of divisions of the target object is input from the operating unit, the control unit causes the image projector to project an image used to divide the target object into the number of divisions.

According to another aspect of the invention, the mobile electronic device further includes a distance detector that detects a distance from the image projector to an irradiated plane to which light emitted by the image projector is irradiated. The control unit performs image processing on an image to be projected by the image projector, and controls an operation of the image projector. When the information for the number of divisions is input from the operating unit, the control unit generates an image for division, detects a size of the irradiated plane from the distance detected by the distance detector, determines the size of the image to be projected from the image projector based on the detected size of the irradiated plane, and causes the image projector to project the image divided by the number of divisions to the irradiated plane.

According to another aspect of the invention, the mobile electronic device further includes: an imaging unit that photographs an image of the irradiated plane; and an image analyzer that analyzes the image photographed by the imaging unit and extracts the target object. The control unit determines a layout of division lines based on a configuration of the target object detected based on a result of detection by the image analyzer.

According to another aspect of the invention, the control unit determines a shape of the division lines based on the configuration of the target object.

According to another aspect of the invention, the control unit determines a layout inhibited area of the division lines from the configuration of the target object, and arranges the division lines at positions that do not overlap the layout inhibited area.

According to another aspect of the invention, the control unit calculates a size of the target object extracted by the image analyzer based on the distance between the irradiated plane and the image projector detected by the distance detector, and determines the size of the image to be projected from the image projector further based on the size of the target object.

According to another aspect of the invention, the mobile electronic device further includes an angle detector that detects an angle between an irradiation direction of the light from the image projector and the irradiated plane. The control unit corrects the image to be projected or an area where an image is projected by the image projector so that the image to be projected to the target object becomes the same shape as that of image data, based on the angle detected by the angle detector.

According to another aspect of the invention, the control unit generates an image based on setting in which the irradiation direction of light from the image projector and the irradiated plane are orthogonal to each other.

According to another aspect of the invention, the control unit adjusts the size of the image so that the target object is projected to the irradiated plane in actual size, based on the detected size of the irradiated plane and the size of the target object.

According to another aspect of the invention, the image for division is a ruler, a protractor, or any device that includes scale marks thereof.

According to another aspect of the invention, the distance detector is a distance measuring sensor.

According to another aspect of the invention, the distance measuring sensor includes a light-emitting element and a light-receiving element, and receives light emitted from the light-emitting element and reflected on the irradiated plane by the light-receiving element, to detect a distance between the image projector and the irradiated plane.

According to another aspect of the invention, the distance measuring sensor includes a light-receiving element, and receives light irradiated from the image projector and reflected on the irradiated plane by the light-receiving element, to detect a distance between the image projector and the irradiated plane.

According to another aspect of the invention, the distance measuring sensor receives infrared rays, to detect a distance between the image projector and the irradiated plane.

According to another aspect of the invention, the distance detector detects a distance using an autofocus function of a photographing system.

According to another aspect of the present invention, a mobile electronic device includes: an operating unit; a display unit; an imaging unit; and a control unit that controls the units. When information about the number of divisions to divide a target object photographed by the imaging unit is input from the operating unit, the control unit controls the display unit so that an image used to divide the target object into the number of divisions and an image of the target object are displayed in a superimposed manner.

According to another aspect of the invention, the mobile electronic device further includes an image analyzer that analyzes an image photographed by the imaging unit and extracts the target object. When information about the number of divisions is input to the operating unit, the control unit determines a location of a division line, generates an image divided into the number of divisions, and displays the image divided into the number of divisions superimposed on an image of the target object detected based on a result of detection by the image analyzer, on the display unit.

### Effect Of The Invention

The mobile electronic device according to the present invention is configured to create an image in which a target object is divided based on the number of divisions and to project or display the created image, which enables the user to recognize the size of the target object and enables the target object to be divided into the number of divisions at a predetermined ratio as necessary.

Moreover, in the mobile electronic device according to the present invention, the distance detector detects a distance to the irradiated plane irradiated with the light and adjusts an image to be projected based on the detected distance, so that there is such an effect that a more serviceable and useful image can be projected.

### BRIEF DESCRIPTION OF DRAWINGS

FIG. 1 is a perspective view illustrating a schematic configuration of one embodiment of a mobile electronic device.

FIG. 2 is a block diagram illustrating a schematic configuration of functions of the mobile electronic device as illustrated in FIG. 1.

FIG. 3 is an explanatory diagram illustrating a state in which an image is displayed by the mobile electronic device as illustrated in FIG. 1.

FIG. 4 is a flowchart illustrating one example of the operation of the mobile electronic device.

FIG. 5 is a flowchart illustrating another example of the operation of the mobile electronic device.

FIG. 6 is a flowchart illustrating another example of the operation of the mobile electronic device.

FIG. 7 is an explanatory diagram illustrating one example of an image to be projected by the mobile electronic device.

FIG. 8 is a flowchart illustrating another example of the operation of the mobile electronic device.

FIG. 9 is an explanatory diagram illustrating an irradiated plane to which an image is projected by the mobile electronic device.

FIG. 10 is a flowchart illustrating another example of the operation of the mobile electronic device.

FIG. 11 is an explanatory diagram illustrating one example of an image to be projected by the mobile electronic device.

FIG. 12 is a flowchart illustrating another example of the operation of the mobile electronic device.

FIG. 13 is an explanatory diagram illustrating one example of an image to be projected by the mobile electronic device.

FIG. 14 is an explanatory diagram illustrating a relationship between the mobile electronic device and a target to be photographed.

FIG. 15 is an explanatory diagram illustrating one example of a method of creating an image to be projected by the mobile electronic device.

FIG. 16A is a schematic diagram illustrating a state in which an image is projected by the mobile electronic device.

FIG. 16B is a schematic diagram illustrating a state in which an image is projected by the mobile electronic device.

### DESCRIPTION OF EMBODIMENTS

The present invention will be explained in detail below with reference to the drawings. It should be noted that the present invention is not limited by the following explanation. Besides, the components explained in the following include those that can be easily thought of by persons skilled in the art, and substantially equivalents or those in an equivalent scope. A mobile phone as a mobile electronic device will be explained hereinafter as an example, however, an applied target of the present invention is not limited to the mobile phone. The present invention can also be applied to, for example, PHS (Personal Handyphone System), PDA, a portable navigation device, a notebook-size personal computer, and a game machine.

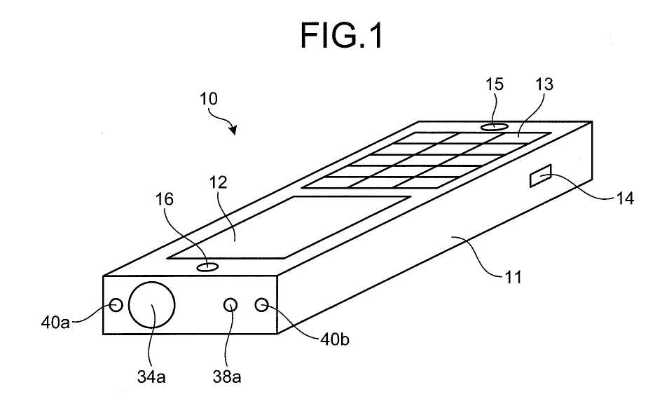

First, an external configuration of the mobile electronic device is explained. FIG. 1 is a perspective view illustrating a schematic configuration of one embodiment of the mobile electronic device. A mobile electronic device 10 is a mobile phone provided with a wireless communication function. The mobile electronic device 10 is a straight mobile phone with units stored inside of one box-shaped housing 11. In the present invention, the housing 11 is formed to a box shape, however, the housing may be formed with two members coupled to each other by a hinge and thereby be foldable, or the housing may be configured to have two members which are slidable. A housing connected with three or more members can also be used.

The housing 11 is provided with a display 12 as a display unit illustrated in FIG. 1. The display 12 displays a predetermined image, such as a standby image when the mobile electronic device 10 is in a standby state for waiting for reception and a menu image used to help operation of the mobile electronic device 10.

The housing 11 is provided with a plurality of operation keys 13 used to enter a telephone number of an intended party or to enter text when an email is created. In addition, a dedicated key 14 for controlling operations of a projector 34, explained later, is provided in one of sides of the housing 11 (one of faces substantially orthogonal to a face where the operation keys 13 are provided). The operation keys 13 and the dedicated key 14 constitute an operating unit of the mobile electronic device 10. The housing 11 is also provided with a microphone 15 that receives a voice during talking on the mobile electronic device 10, and with a receiver 16 that emits voice during talking on the mobile electronic device 10.

A light emitting portion 34a of the projector 34 for projecting an image is provided on a top face of the housing 11 (one side of the top face meets a face where the operation keys 13 are provided and one side of the other sides meets a face where the dedicated key 14 is provided). Further provided on the top face of the housing 11 are an imaging portion 38a of a camera 38, and a transmitter 40a and a receiver 40b of a distance measuring sensor 40.

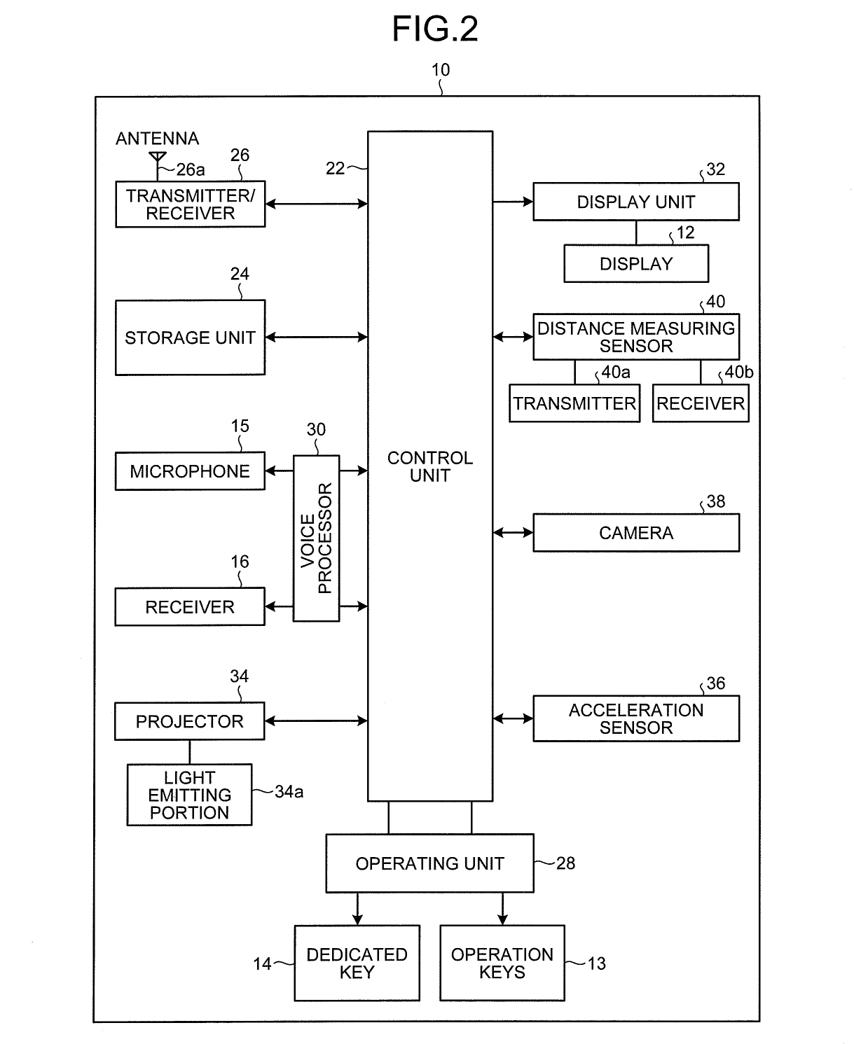

FIG. 2 is a block diagram illustrating a schematic configuration of functions of the mobile electronic device as illustrated in FIG. 1. As illustrated in FIG. 2, the mobile electronic device 10 includes a control unit 22, a storage unit 24, a transmitter/receiver 26, an operating unit 28, a voice processor 30, a display unit 32, the projector 34, an acceleration sensor 36, the camera 38, and the distance measuring sensor 40.

The control unit 22 is a processor such as a CPU (central processing unit) that integrally controls an overall operation of the mobile electronic device 10. That is, the control unit 22 controls the operations of the transmitter/receiver 26, the voice processor 30, and the display unit 32 or the like so that the various processes of the mobile electronic device 10 are executed in an appropriate sequence according to the operation of the operating unit 28 and software stored in the storage unit 24 of the mobile electronic device 10. The various processes of the mobile electronic device 10 include, for example, voice communication performed through a line switching network, creation and transmission/reception of an electronic mail, and browsing to a Web (World Wide Web) site on the Internet. In addition, the operations of the transmitter/receiver 26, the voice processor 30, and the display unit 32 or the like include signal transmission/reception by the transmitter/receiver 26, voice input/output by the voice processor 30, and display of an image by the display unit 32.

The control unit 22 executes processes based on programs (e.g., operating system program and application programs) stored in the storage unit 24. The control unit 22 is formed with, for example, a MPU (Micro Processing Unit), and executes the various processes of the mobile electronic device 10 according to the sequence instructed by the software. That is, the control unit 22 sequentially loads operation codes from the operating system program and the application programs stored in the storage unit 24, and executes the processes.

The control unit 22 has a function of executing a plurality of application programs. The application program executed by the control unit 22 includes a plurality of application programs such as an application program for controlling the drive of the projector and game application programs for activating various games.

The storage unit 24 stores therein software and data used for processes performed by the control unit 22, a task for activating an application program that controls the drive of the projector and a task for activating various game application programs.

The storage unit 24 stores therein, in addition to these tasks, for example, voice data through communication and downloaded sound data, software used by the control unit 22 for controlling the storage unit 24, an address book for saving and managing telephone numbers and email addresses of communication opposite parties, a sound file of a dial tone and a ring tone or the like, and temporary data used for a process of software. The storage unit 24 further stores therein data for an image including size information about an object (target object). Computer programs and temporary data used for the processes of the software are temporarily stored in a work area allocated to the storage unit 24 by the control unit 22. The storage unit 24 is formed with, for example, a nonvolatile storage device (e.g., nonvolatile semiconductor memory such as ROM (Read Only Memory), and a hard disk drive), and a randomly accessible storage device (e.g., SRAM (Static Random Access Memory), and DRAM (Dynamic Random Access Memory)).

The transmitter/receiver 26 includes an antenna 26a, and establishes a wireless signal line based on CDMA system with a base station through a channel allocated by the base station, and performs telephone communication and information communication with a base station.

The operating unit 28 is formed with the operation keys 13 such as Power key, Talk key, Numeric keys, Character keys, Direction key, OK key, and Send key to which various functions are allocated respectively, and with the dedicated key 14. When these keys are used to enter information through the operation by the user, the operating unit 28 emits a signal corresponding to the content of the operation. The emitted signal is input to the control unit 22 as an instruction of the user.

The voice processor 30 executes processes of a voice signal input to the microphone 15 and a voice signal output from the receiver 16. That is, the voice processor 30 amplifies the voice input through the microphone 15, subjects the voice to AD conversion (Analog to Digital conversion), then further subjects the voice to signal processing such as coding, converts the coded voice to digital voice data, and outputs the digital voice data to the control unit 22. Moreover, the voice processor 30 decodes the digital voice data sent from the control unit 22, subjects the decoded data to DA conversion (Digital to Analog conversion), subjects the converted data to processes such as amplification to be converted to an analog voice signal, and outputs the analog voice signal to the receiver 16.

The display unit 32 is provided with a display panel (such as the display 12) formed with a LCD (Liquid-Crystal Display) or an organic EL (Organic Electro-Luminescence) panel or the like. The display unit 32 displays a video image according to video data supplied from the control unit 22 and an image according to image data on the display panel.

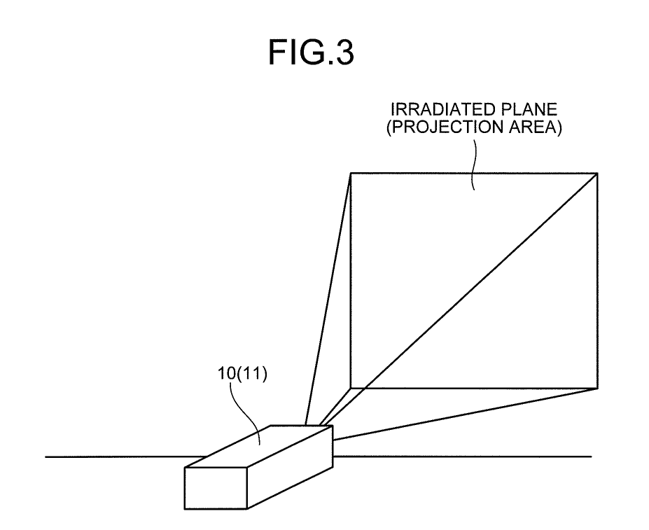

The projector 34 is an image projection mechanism for projecting an image, and, as explained above, is provided with the light emitting portion 34a for projecting an image, on the top face of the housing 11. FIG. 3 is an explanatory diagram illustrating a state in which an image is displayed by the mobile electronic device as illustrated in FIG. 1. The mobile electronic device 10 projects an image from the light emitting portion 34a of the projector 34. In other words, by emitting the light forming the image, as illustrated in FIG. 3, an image can be projected to a given area (projection area) of a wall surface or a screen on a plane opposite to the top face of the housing 11. The operation of projector 34 is controlled by the control unit 22, so that various video images such as films and presentation materials sent from the control unit 22 are projected and displayed on the projection area.

The projector 34 is formed with a light source and an optical system that switches whether the light emitted from the light source is projected, according to the image data. For example, a projector configured with a halogen light, a LED light source, or an LD light source as the light source and with an LCD (Liquid Crystal Display) or a DMD (Digital Micro-mirror Device) as the optical system can be used as the projector 34. In this case, the optical system is provided over the whole area of the projection area corresponding to pixels, and the optical system is turned on or off by synchronizing the light emitted from the light source with the image, so that the image can be projected over the whole area of the projection area. A projector configured with a light source that emits laser light, and with an optical system that includes a switching element for switching whether the light emitted from the light source is to be transmitted and a mirror for subjecting the light having passed through the switching element to raster scanning can be used as the projector 34. In this case, by changing an angle of the light emitted from the laser light by the mirror and scanning the light irradiated from the light source over the whole area of the projection area, the image can be projected to the projection area.

The acceleration sensor 36 is a detector that detects an acceleration applied to the housing 11. As the acceleration sensor 36, a detector that detects an acceleration using various methods can be used. For example, a detector that detects an acceleration based on a change in capacitance, a change in piezo resistance, or a change in relative positions can be used. The acceleration sensor 36 detects, for example, an acceleration due to gravity or an acceleration acting on the housing 11 when the operator moves or shakes the housing 11.

The camera 38 is an imaging system in which the imaging portion 38a provided on the top face of the housing 11 captures an image of an area including a projection area. In other words, the camera 38 captures an image in a direction of light emitted by the projector 34. It should be noted that the camera 38 is a photographing system for photographing an image at an angle of view wider than an angle of view of an image irradiated by the projector 34, and thus can photograph an image of an area wider than a projection area to which an image is projected by the projector 34.

The distance measuring sensor 40 is a measuring device for measuring a distance to a plane to which the projector 34 emits light, that is, a plane to which an image of a projection area emitted from a face comes and on which the image is displayed (hereinafter, “irradiated plane”). The distance measuring sensor 40 includes the transmitter 40a which is provided on the top face of the housing 11 and emits a measurement wave such as an infrared ray, an ultrasonic wave, and a laser light; and the receiver 40b which is provided on the top face of the housing 11 and receives the measurement wave. The receiver 40b receives the measurement wave emitted from the transmitter 40a and reflected by a target object. The distance measuring sensor 40 calculates a distance between the distance measuring sensor 40 and the irradiated plane based on the intensity of the measurement wave received by the receiver 40b, an incident angle of the measurement wave, and a time from transmission of the measurement wave by the transmitter 40a to reception thereof by the receiver 40b. The mobile electronic device 10 is configured basically as above.

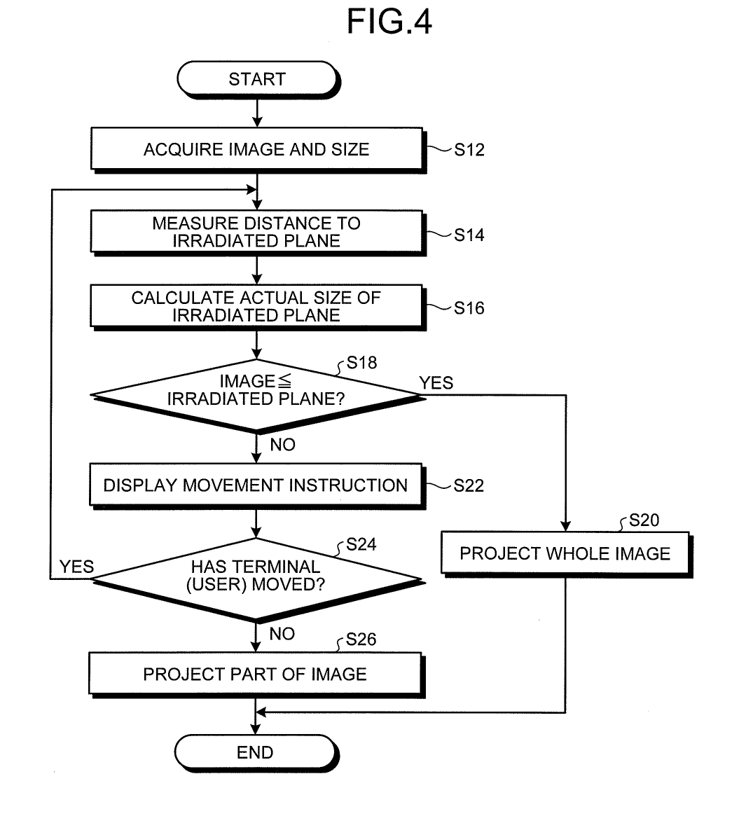

Next, the operation of the mobile electronic device 10, specifically, the control operation of the projector will be explained with reference to FIG. 4. FIG. 4 is a flowchart illustrating one example of the operation of the mobile electronic device. The flowchart illustrated in FIG. 4 is an example of controlling the operation of the projector 34 when an image of an object whose size is known is displayed.

First, when the image to be displayed is specified by the operator, the control unit 22 acquires the specified image and its size as Step S12. Specifically, the control unit 22 acquires data for the specified image and size information about the object included in the image, that is, size information about the target object. These data are acquired from a medium having the image specified by the user. When these data are stored in the storage unit 24, then they are read from the storage unit 24, while when these data are stored in a server connected to the mobile electronic device through communication, then they are read from the server through the transmitter/receiver 26. If size information is added to the image data, the size information added to the image data may be acquired.

After acquiring the image and the size at Step S12, the control unit 22 measures a distance to the irradiated plane (projected plane) as Step S14. Specifically, the distance measuring sensor 40 calculates a distance from the light emitting portion 34a of the projector 34 to the irradiated plane. After measuring the distance to the irradiated plane at Step S14, the control unit 22 calculates an actual size of the irradiated plane as Step S16. Specifically, the control unit 22 calculates the actual size of the irradiated plane or its extent or its area based on the distance to the irradiated plane calculated at Step S14 and an irradiation angle of the light emitted from the projector 34. The actual size of the irradiated plane may be calculated by previously storing a relationship between a reference distance and a reference area, for example, the size of an irradiated plane when the distance is 50 cm and performing proportional calculation using the distance measured at Step S14.

After calculating the size of the irradiated plane at Step S16, the control unit 22 determines whether the image ≦ the irradiated plane as Step S18. In other words, the control unit 22 compares the size of the image to be projected on the irradiated plane with the size of the irradiated plane and determines whether the image fits in the irradiated plane.

When it is determined at Step S18 that the image ≦ the irradiated plane (Yes), that is, when it is determined that the size of the image is equal to the size of the irradiated plane or the size of the image is smaller than the size of the irradiated plane, the control unit 22 causes the projector 34 to project a whole image as Step S20. Specifically, the control unit 22 enlarges or reduces an image to be projected to the irradiated plane so that the image to be projected becomes the actual size, based on the size of the image and the size of the irradiated plane, and causes the projector 34 to project the image. When the size of the image and the size of the irradiated plane are the same as each other, the control unit 22 causes the projector 34 not to enlarge or reduce the image to be projected but to project the image as it is. After the projection of the image is terminated at Step S20, the control unit 22 ends the process.

When it is determined at Step S18 that the image > the irradiated plane (No), that is, when it is determined that the size of the image is greater than the size of the irradiated plane, the control unit 22 displays a movement instruction of the mobile electronic device 10 as Step S22. Specifically, in order to project the whole image in its actual size, the distance to the irradiated plane needs to be longer, so that a message that the mobile electronic device 10 needs to be moved in a direction away from the irradiated plane is displayed on the display 12 of the display unit 32.

After the movement instruction is displayed at Step S22, the control unit 22 determines whether a terminal, that is, the mobile electronic device 10 has moved as Step S24. Here, how to determine whether the mobile electronic device 10 has moved is not particularly limited. For example, it is determined based on an acceleration detected by the acceleration sensor 36. Specifically, it may be determined that the mobile electronic device 10 has moved when an acceleration in a given direction for a give time or more is detected by the acceleration sensor 36. Moreover, the distance to the irradiated plane is measured by the distance measuring sensor 40, and results of detection may be compared with each other. The determination at Step S24 may be performed in such a manner that it is determined whether the mobile electronic device 10 has moved during a given time after the display of the movement instruction at Step S22. Otherwise, the determination may be performed in such a manner that it is determined whether the mobile electronic device 10 has moved during the time between the display of the movement instruction at Step S22 and the input of an instruction to terminate the determination by the operator.

When it is determined at Step S24 that the terminal has moved (Yes), the control unit 22 proceeds to Step S14. In other words, when the distance to the irradiated plane changes, the control unit 22 performs the processes from Step S14 to Step S18, and again determines whether the whole image can be displayed on the irradiated plane.

When it is determined at Step S24 that the terminal has not moved (No), the control unit 22 projects part of the image as Step S26. Specifically, the control unit 22 calculates the size of the image which can be projected to the irradiated plane based on the size of the irradiated plane, selects a portion to be projected from the image based on the calculated size, or clips a given area, and projects an image of the selected portion in the actual size. The method of selecting the portion to be projected from the image is not particularly limited. The portion may be selected by the operator. Otherwise, the portion of the image that fits the irradiated plane on condition that the center of the image is positioned at a center of the irradiated plane may be selected automatically. After the part of the image is projected at Step S26, the control unit 22 ends the process.

As explained above, the mobile electronic device 10 detects the distance to the irradiated plane by the distance measuring sensor 40. Accordingly, the mobile electronic device 10 can project the image, that is, the object included in the image in the actual size (the size stored in the image data) to the irradiated plane, based on the result of detection. Thus, the mobile electronic device 10 can project the object included in the image in a give size regardless of the distance to the irradiated plane. This enables the operator to accurately recognize the size of the object and to easily estimate the actual size even if the display is limited in the display 12 and the real thing of an object (subject) is difficult to be imagined. For example, when the operator buys a thing on the Internet or the like, it is difficult for the operator to imagine its size when the thing is only displayed on the display 12, however, projection of the object by the projector 34 of the mobile electronic device 10 enables the operator to estimate the size of the real thing. In addition, for example, when the object is clothes, a video image thereof is projected to the operator's body, so that the operator can check their sleeve length and whole length when he/she is wearing the clothes. When the object is furniture or the like, by projecting its image to a location where the furniture is supposed to be laid out, the operator can easily recognize the layout as to whether the furniture fits into the space can be easily recognized.

The embodiment is configured to project an actual-sized or life-sized object, however, the present invention is not limited thereto. Therefore, the object may be projected in an arbitrary size obtained by reducing or enlarging the actual size based on the setting by the operator or a preset magnification. In this manner, by projecting an object in a known magnification, it is possible for the operator to easily imagine the actual size of the object even if the size is not the actual size.

When a type of projector from which an image is projected by scanning light along the irradiated plane is used as the projector 34 and the size of the image to be projected is smaller than an area projectable by the projector 34, the light may be scanned only on the area of the image to be projected. In other words, the area scanned with the light by the projector 34 may be changed according to the size of the image to be projected. This enables an amount of light scanning to be reduced and power used for image projection to be reduced.

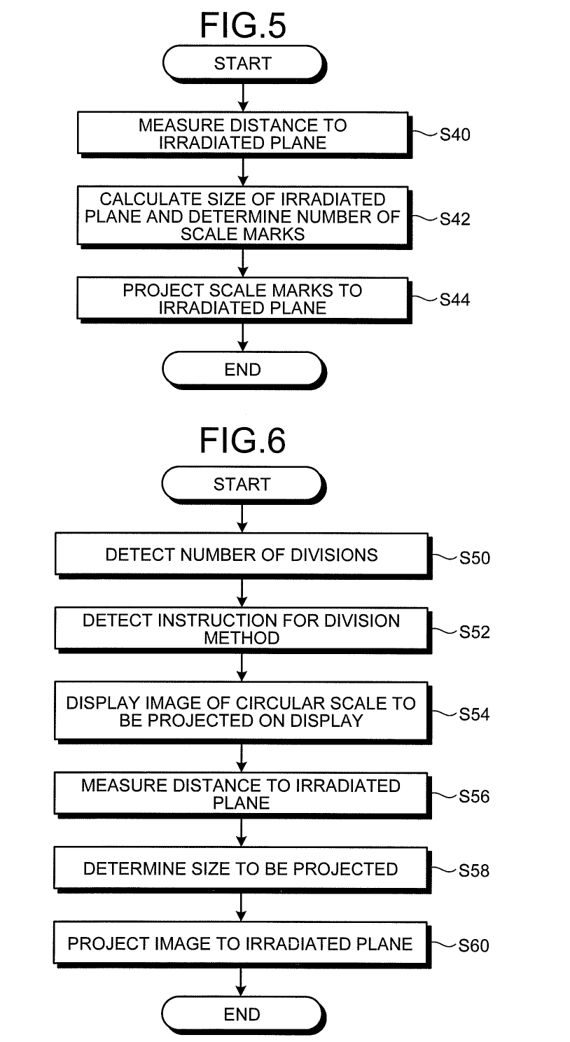

The mobile electronic device 10 preferably projects a ruler or a scale as an object. In this case, the length of the ruler to be projected is preferably changed according to the size of the irradiated plane. The operation together with a specific control will be explained below with reference to FIG. 5. FIG. 5 is a flowchart illustrating another example of the operation of the mobile electronic device.

First, when projection of the ruler as an object is selected through the operation by the operator, the control unit 22 measures a distance to the irradiated plane (projected plane) as Step S40. Specifically, the distance measuring sensor 40 calculates a distance from the light emitting portion 34a of the projector 34 to the irradiated plane. After measuring the distance to the irradiated plane at Step S40, the control unit 22 calculates the size of the irradiated plane and determines the number of scale marks as Step S42. Here, the size of the irradiated plane can be calculated in the same method as that of the actual size. The number of scale marks is calculated from the calculated size of the irradiated plane. In other words, supposing the scale marks are shown in units of cm, if the size of the irradiated plane is 50 cm, then the number of scale marks is 50, and if the size of the irradiated plane is 63 cm, then the number of scale marks is 63. The control unit 22 creates an image (or a screen of scale marks) in which the scale marks of the calculated number are serially connected to each other. The control unit 22 may add numbers each indicating a length according to the number of scale marks. In other words, like an ordinary ruler, a number 10 may be added to the scale mark at 10 cm from the edge of the ruler and a number 20 may be added to the scale mark at 20 cm from the edge thereof.

After calculating the size of the irradiated plane, determining the number of scale marks, and creating the screen of the scale marks at Step S42, the control unit 22 projects the created image of the scale marks to the irradiated plane, and ends the process. The control unit 22 continuously projects the image of the scale marks until a termination instruction is received or during a given time.

In this way, by calculating the size of the irradiated plane and projecting the image of the scale marks indicating the actual size based on the distance to the irradiated plane calculated by the distance measuring sensor 40, the length of an area projected with light can be measured. With this feature, by projecting the image of the scale marks to a target object that the operator desires to know its length, the length of the target object can be measured. This enables the length of the target object to be measured if the operator has the mobile electronic device 10 even if he/she does not have a ruler. In addition, by adjusting the distance to the target object and adjusting the size of the irradiated plane, the length of the scale marks displayed on the image of the scale marks can be changed. Therefore, one mobile electronic device 10 can be used as various-sized rulers.

As for the image of the scale marks, the scale marks may be displayed over the whole area of the irradiated plane or may be displayed only part thereof. A location where the scale marks are displayed within the screen is not particularly limited, and thus the scale marks may be displayed only in the horizontal direction of the screen or only in the vertical direction thereof, may be displayed in both directions, may be displayed in an oblique direction, or may be displayed in a matrix like a graph paper. In addition, the method of creating the scale marks to be displayed is not limited. Therefore, for example, the method may be such that a ruler image with a possible maximum length is stored, an area to be used, of the ruler image, is determined based on the length of the irradiated area, and the ruler image for the determined area is projected as an image.

The embodiment has explained the case where a linear ruler is displayed, however, a scale in a circle may be displayed. The scale in the circle together with specific control will be explained below with reference to FIG. 6. FIG. 6 is a flowchart illustrating another example of the operation of the mobile electronic device. The flowchart illustrated in FIG. 6 is a flowchart in which lines used to divide the circle into a plurality of sections in its circumferential direction are displayed inside the scale in the circle (hereinafter, “circular scale”). The circular scale is a scale having a preset length of a radius of its outer circumference.

First, when an instruction to display the circular scale input by the operator is detected, the control unit 22 detects the number of divisions as Step S50, and further detects an instruction for a division method as Step S52. Specifically, the control unit 22 displays a screen for inputting the number of divisions, and thereafter detects the number of divisions of the circle input by the operator. Furthermore, the control unit 22 displays a screen so as to prompt the operator to select whether the divisions are obtained by equally dividing the circle or by dividing the circle at a different ratio, and detects the instruction input by the operator. When it is divided at a different ratio, the control unit 22 displays a screen so as to prompt the operator to input a ratio for division, and detects the result of input of each ratio. After detecting the number of divisions at Step S50 and detecting the division method at Step S52, the control unit 22 displays an image of the circular scale to be projected on the display 12 as Step S54. In other words, the control unit 22 displays an image intended to be projected on the display 12 before it is projected by the projector 34.

After displaying the circular scale on the display 12 at Step S54, the control unit 22 measures a distance to the irradiated plane (projected plane) as Step S56. Specifically, the distance measuring sensor 40 calculates a distance from the light emitting portion 34a of the projector 34 to the irradiated plane. After measuring the distance to the irradiated plane at Step S56, the control unit 22 determines the size to be projected as Step S58. In other words, the control unit 22 generates image data so that the size of the circular scale becomes the set size on the irradiated plane, based on the distance to the irradiated plane and the size of the circular scale. When the size to be projected is determined at Step S58, the control unit 22 projects the created image to the irradiated plane at Step S60, and ends the process. In other words, the control unit 22 projects the circular scale, divided into an arbitrary number, in the set size.

In this manner, by projecting an image in which the circular scale is divided into sections, when a circular object such as a cake is to be divided, it can be divided at a desired ratio. In other words, by cutting the cake along lines that divide the circular scale, the cake can be divided at a desired ratio. In addition, by setting the radius of the outer circumference of the circular scale to a give value, even if the distance to the target object changes, the same image can be continuously projected to the target object unless the circular scale becomes larger than the irradiated plane. It goes without saying that an image representing degrees like a protractor may be projected.

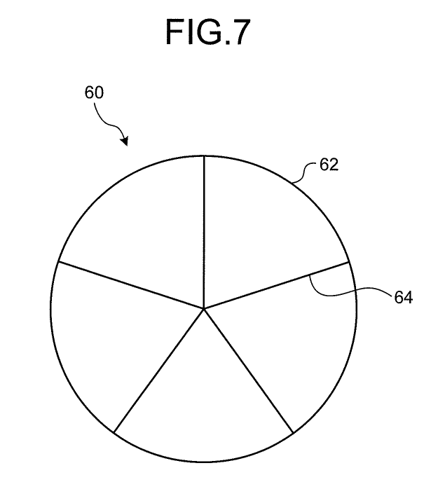

FIG. 7 is an explanatory diagram illustrating one example of an image to be projected by the mobile electronic device. The mobile electronic device 10 creates an image 60 illustrated in FIG. 7 by the process illustrated in FIG. 6. Here, the image 60 is formed with a circular scale 62 and a plurality of division lines 64 that divide the circular scale 62. The circular scale 62 of the image 60 is formed only with a visible outline. In this way, by projecting the image having the division lines 64 to a target object, the target object can be divided into a desired shape and number.

By displaying the image of the irradiated plane photographed and the image intended to be projected on the display 12 in a superimposed manner at Step S54, the mobile electronic device 10 enables check of a relationship between the state of the irradiated plane and the screen intended to be projected on the screen. The mobile electronic device 10 may display the image intended to be projected on the display 12 at Step S54 without superimposing the image intended to be projected on the image of the irradiated plane photographed.

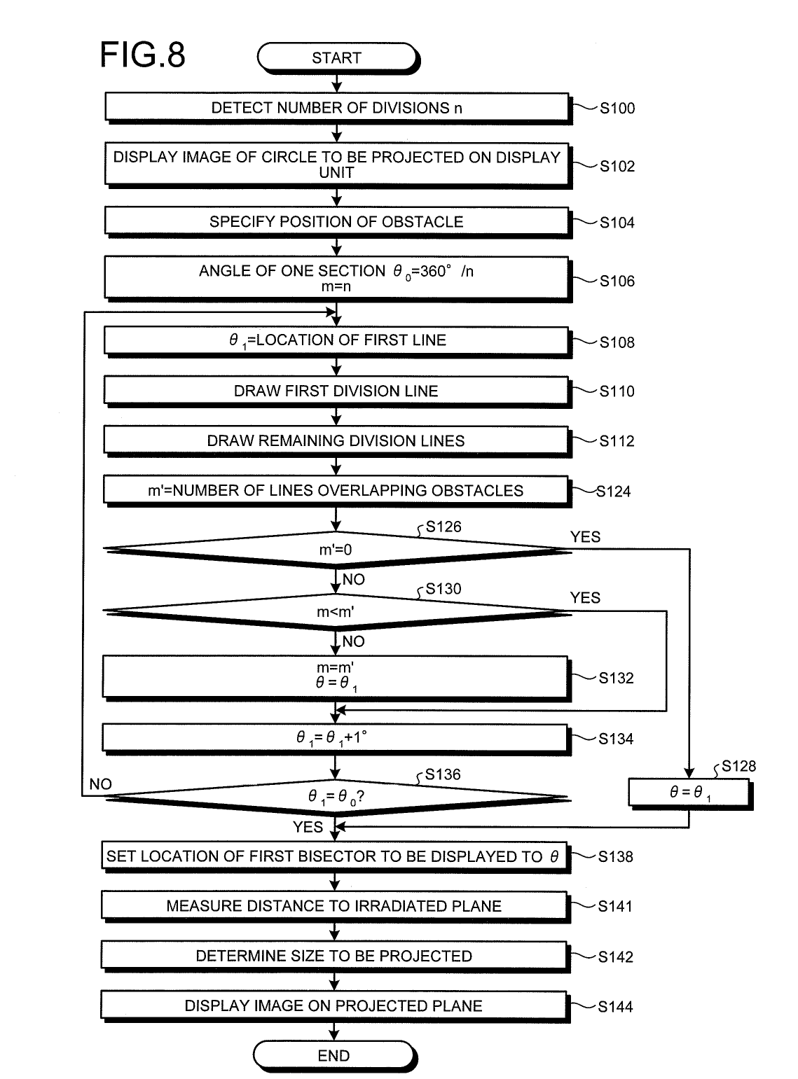

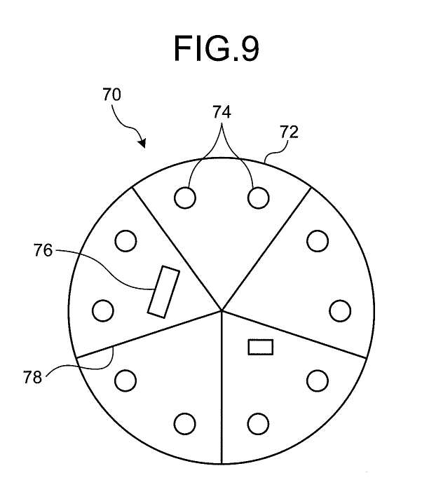

Another control of the mobile electronic device will be explained below with reference to FIG. 8 and FIG. 9. FIG. 8 is a flowchart illustrating another example of the operation of the mobile electronic device, and FIG. 9 is an explanatory diagram illustrating an irradiated plane to which an image is projected by the mobile electronic device. The flowchart illustrated in FIG. 8 is an example of operation in which obstacles are detected from the configuration of a target object (object arranged on the irradiated plane) of an image and division lines are projected and displayed avoiding the obstacles.

First, the control unit 22 of the mobile electronic device 10 detects the number of divisions n of the circle input by the operator as Step S100. When the number of divisions is detected at Step S100, the control unit 22 displays an image of a circle to be projected on the display unit 32 as Step S102. In other words, the control unit 22 creates an image of the circle divided based on the number of divisions received at Step S100, and displays the created image on the display unit 32.

After the image to be projected is displayed on the display unit 32 at Step S102, the control unit 22 specifies a position of the obstacle as Step S104. Specifically, the control unit 22 acquires an image of an irradiated area by the camera 38 and specifies a target object. The method of specifying the target object is not particularly limited. For example, the control unit 22 can analyze a photographed image, extract a circular object or an object of a shape corresponding to the scale, and determine the extracted object as a target object. The control unit 22 may display the photographed image on the display unit 32 and specify the position of the target object created through a user operation. In this case, the image created at Step S102 is also displayed, the photographed image and the created image can be relatively moved through the user operation, and the positions of the created image of the circle and of the target object within the photographed image are superimposed, so that the target object can also be specified. After the target object is specified, the control unit 22 analyzes the image of the target object and specifies a position of the obstacle (that is, an area where the layout of the division lines should be avoided) on the surface of the target object. For example, when the target object is a cake, the obstacle can be a fruit (strawberry), a bar of chocolate, and an ornament (candy work) arranged on the surface of the cake. The basis as to what is determined as an obstacle is set by the user. For example, it may be set so that the strawberry is not an obstacle but the bar of chocolate is an obstacle, or it may be set so that both the strawberry and the bar of chocolate are obstacles.

After specifying the position of the obstacle at Step S104, the control unit 22 calculates an angle of one section and sets a control value m as Step S106. Here, the control unit 22 calculates an angle θ₀ between a division line and its adjacent division line. Specifically, it is calculated by using an angle θ₀=360°/n, where n is the number of divisions detected at Step S100. The control value m is set as m=n. The control value m is a value used when a location of the division line is determined. As for the control value m, the number n of the division lines is set as default value.

After the process at Step S106 is ended, the control unit 22 sets θ₁ to the location of a first division line as Step S108, and draws the first division line (or determines the location of the first division line) as Step S110. Here θ₁ is an angle with respect to normal coordinates (circular polar coordinates as a reference on the screen and the projected image). As for θ₁, 0 is set as default value.

When the location of the first division line is determined at Step S110, the control unit 22 draws remaining division lines as Step S112. In other words, the control unit 22 determines locations of the division lines at an interval of angle θ₀ based on the location of the first division line. This enables to specify locations of n-division lines in the image.

When the locations of the division lines are determined at Step S112, the control unit 22 detects the number, as m′, of division lines that overlap the obstacles as Step S124. Whether the division lines overlap the obstacles can be detected by comparing the positions of the obstacles specified at Step S104 with the division lines drawn at Step S112 on the normal coordinates. The control unit 22 sets m′ to the detected number of division lines overlapping the obstacles.

When the number m′ of division lines is detected at Step S124, the control unit 22 determines whether m′=0, that is, whether the number of division lines overlapping the obstacles is zero as Step S126. When it is determined at Step S126 that m′=0 (Yes), the control unit 22 sets θ=θ₁ as Step S128. In other words, control unit 22 sets θ to an angle of the angle θ₁ at which m′=0. When setting θ=θ₁ at Step S128, the control unit 22 proceeds to Step S138.

When it is determined at Step S126 that m′ is not zero (No), that is, there is a division line overlapping the obstacle under a current condition, the control unit 22 determines whether m<m′ as Step S130. In other words, the control unit 22 determines whether the set control value m is smaller than the number m′ as Step S130.

When it is determined at Step S130 that m<m′ (Yes), that is, the set control value m is smaller than the number m′, the control unit 22 proceeds to Step S134. When it is determined at Step S130 that m′ is not smaller than m′ (No), or when it is determined that m≧m′, that is, the set control value m is equal to or greater than the number m′, then the control unit 22 sets m=m′ and θ=θ₁ as Step S132. In other words, the control unit 22 sets a new control value m to the number m′ calculated most recently, and sets new θ to θ₁ corresponding to the number m′ calculated most recently. Thereafter, the control unit 22 proceeds to Step S134.

When it is determined as Yes at Step S130 or when the process at Step S132 is ended, the control unit 22 sets θ₁=θ₁+1° as Step S134. In other words, the control unit 22 sets new θ₁ to an angle obtained by adding 1° to the most recent θ₁.

When θ₁ is set at Step S134, the control unit 22 determines whether θ₁=θ₀ as Step S136. In other words, the control unit 22 determines whether θ₁ whose default value is 0 becomes θ₀. When it is determined at Step S136 that θ₁ is not θ₀ (No), that is, θ₁ is smaller than θ₀, the control unit 22 proceeds to Step S108, and repeats the processes. The control unit 22 repeats the processes to shift the location of the first division line 1° by 1° from 0 to θ₀, so that the locations of the division lines can be determined By shifting the first division line by one section, each of the other division lines thereby shifts one section within the corresponding sections, this results in detection of the location of the division line for a full circle.

When it is determined at Step S136 that θ₁=θ₀ (Yes), that is, the location of the first division line is caused to shift from 0 to θ₀ to determine the locations of the division lines, or when the process at Step S128 is performed, then the control unit 22 sets the first location of the division lines to be displayed to θ as Step S138. Based on this, when an angle at which the division lines do not overlap the obstacles is detected during repetitive calculation, the control unit 22 sets the angle as θ, and proceeds to Step S141. When an angle at which the division lines do not overlap the obstacles can not be detected even if the calculation for one section is repeated, the control unit 22 sets the angle θ₁ at which the number of division lines overlapping the obstacles is the minimum as θ, and proceeds to Step S141 in this state. Therefore, the control unit 22 sets the location of the first division line to θ, and determines locations of the other division lines based on the first division line.

When the location of the division line is determined at Step S138, the control unit 22 measures a distance to the irradiated plane (projected plane) as Step S141. After measuring the distance to the irradiated plane at Step S141, the control unit 22 determines the size to be projected as Step S142. In other words, the control unit 22 generates image data so that the size of the circular scale is made to the set size on the irradiated plane based on the distance to the irradiated plane and the size of the circular scale. When the size to be projected is determined at Step S142, the control unit 22 projects the created image to the irradiated plane as Step S144 and ends the process. In other words, the control unit 22 projects the scale of the circle divided into an arbitrary number in the set size.

By determining the locations of the division lines in the above manner, as illustrate in FIG. 9, the control unit 22 can project an image 70, which is formed with a circular scale 72 and division lines 78, at a positional relationship in which the division lines 78 do not overlap obstacles 74 and an obstacle 76 in the target object as much as possible. The obstacles 74 of the target object illustrated in FIG. 9 are fruits such as strawberries, and the obstacle 76 is the bar of chocolate with a message thereon. In this way, by dividing the target object based on the division lines projected onto the target object, the user can divide the target object into a desired number with the same area as each other while avoiding the obstacles as much as possible.

In the embodiment, m<m′ is set at Step S130, however, m<m′ may be set. In other words, when there are two θ₁ in which the same m is detected, the last detected θ₁ is set as θ in the embodiment, however, the first detected θ₁ may be set as θ.

In the embodiment, sections are divided based on the same area as each other, however, the respective sections can be set so that their areas are different from each other. The circular scale 72 of the image 70 preferably coincides with the outline of the target object, however, the circular scale 72 does not necessarily coincide with the outline. In other words, either one of the circular scale 72 projected to the irradiated plane or the target object may be larger than the other.

In the embodiment, the obstacle is detected by the control unit 22, however, the present invention is not limited thereto, and thus the user may perform setting for the obstacle. In other words, the control unit 22 of the mobile electronic device 10 may detect information about the obstacle input by the user and determine locations where the division lines are laid out based on the detected information. After the obstacle is detected by the control unit 22, the user may additionally input position information about obstacles.

In the embodiment, the location is determined based on whether the division line passes through the obstacle, however, the condition can be set as various conditions. For example, it may be set so that an edge of the obstacle is permitted. A priority is set between the center and the edge of the obstacle, and a location of the division line may be calculated so that the division line does not pass through the center of the obstacle as much as possible.

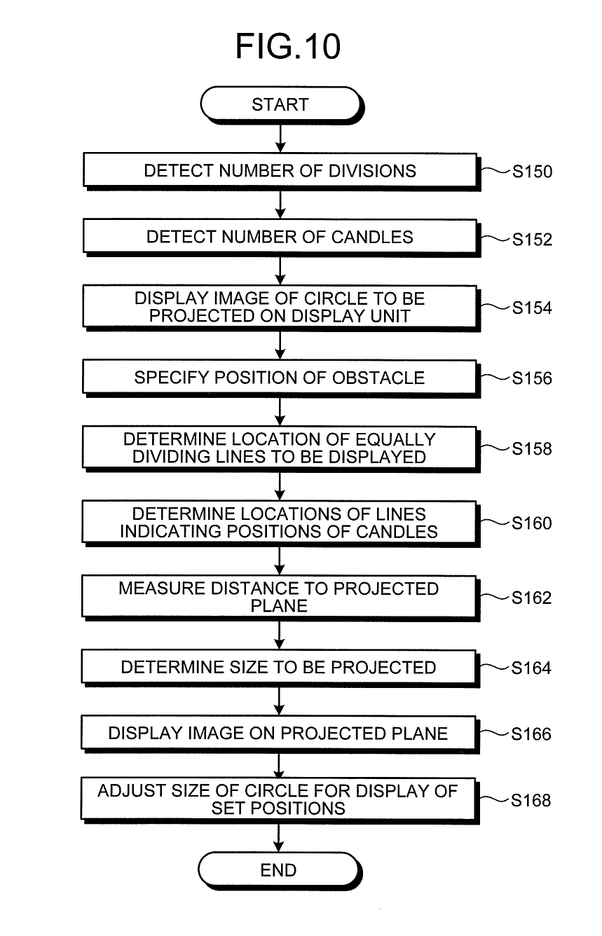

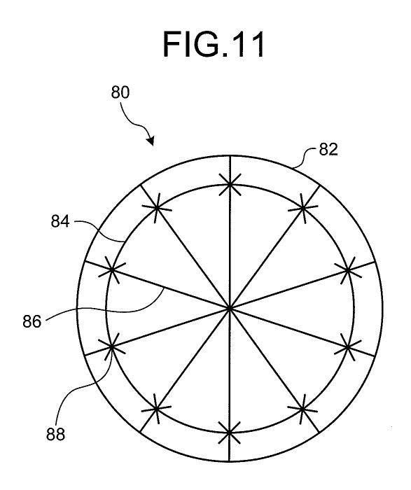

Another control of the mobile electronic device will be explained below with reference to FIG. 10 and FIG. 11. FIG. 10 is a flowchart illustrating another example of the operation of the mobile electronic device, and FIG. 11 is an explanatory diagram illustrating an irradiated plane projected with an image by the mobile electronic device. The flowchart illustrated in FIG. 10 is one example of operations in which, in addition to the division lines, feature points (positions where candles are arranged) at given intervals are projected to and displayed on the target object (object arranged on the irradiated plane) of the image.

First, the control unit 22 of the mobile electronic device 10 detects the number of divisions of the circle input by the operator as Step S150. After detecting the number of divisions at Step S150, the control unit 22 detects the number of candles as Step S152. After detecting the number of candles at Step S152, the control unit 22 displays the image of the circle to be projected on the display unit 32 as Step S154. In other words, the control unit 22 creates an image of the circle divided based on the number of divisions received at Step S150, and displays the created image on the display unit 32.

After displaying the image to be projected on the display unit 32 at Step S154, the control unit 22 specifies the position of the obstacle as Step S156. The method of specifying the obstacle is the same as that at Step S104, and therefore explanation is omitted.

After specifying the position of the obstacle at Step S156, the control unit 22 determines locations of equally dividing line (division lines) to be displayed as Step S158. The method of determining the locations of the equally dividing line is the same as the processes from Step S106 to Step S138 in FIG. 8, and therefore explanation thereof is omitted.

After the locations of the equally dividing line are determined at Step S158, the control unit 22 determines locations of lines (feature points) indicating positions of candles as Step S160. The positions of the candles are determined based on a distance from the outer circumference of the target object (cake) and arrangement intervals. The positions where candles are arranged are calculated at positions avoiding the obstacles, using the same method as above.

When the positions of the candles are determined at Step S160, the control unit 22 measures a distance to the irradiated plane (projected plane) as Step S162. After measuring the distance to the irradiated plane at Step S162, the control unit 22 determines the size to be projected as Step S164. In other words, the control unit 22 generates image data so that the size of the circular scale becomes the set size on the irradiated plane, based on the distance to the irradiated plane and the size of the circular scale. When the size to be projected is determined at Step S164, the control unit 22 projects the created image to the irradiated plane as Step S166. After projecting the image to the irradiated plane at Step S166, the control unit 22 adjusts the size of the circle for display of set positions as Step S168. In other words, the control unit 22 adjusts the size of the circle that connects the positions where the candles are arranged. The circle may be adjusted based on the operation by the operator, or the control unit 22 may acquire the projected image by the camera 38 and adjust the circle based on the result of acquisition. After adjusting the size of the circle at Step S168, the control unit 22 ends the process.

As explained above, the control unit 22 displays the lines indicating the positions where the candles are arranged. Accordingly, the control unit 22 can create an image 80 formed with, as illustrated in FIG. 11, a circular scale 82, a circle 84 for display of set positions, division lines 86, and lines (marks) 88 indicating positions where the candles are arranged, and can project the created image. In the example illustrated in FIG. 11, the locations of the division lines are set as the same angle as the angle of the arrangement positions of the candles, however, the arrangement angles (e.g., the number of divisions and the number of candles) can also be set as a different angle. Moreover, the candles may be arranged in two rounds (double circle).

This enables the user to equally arrange the candles with a simple operation while avoiding the obstacles. In the embodiment, the arrangement intervals of the candles may also be set as different intervals.

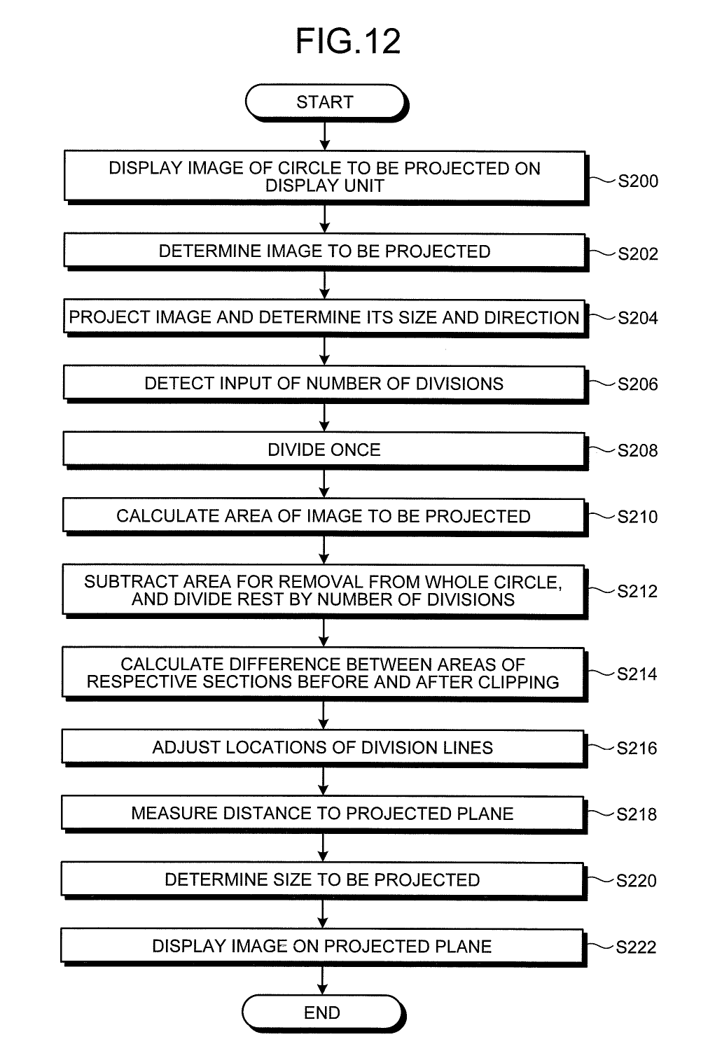

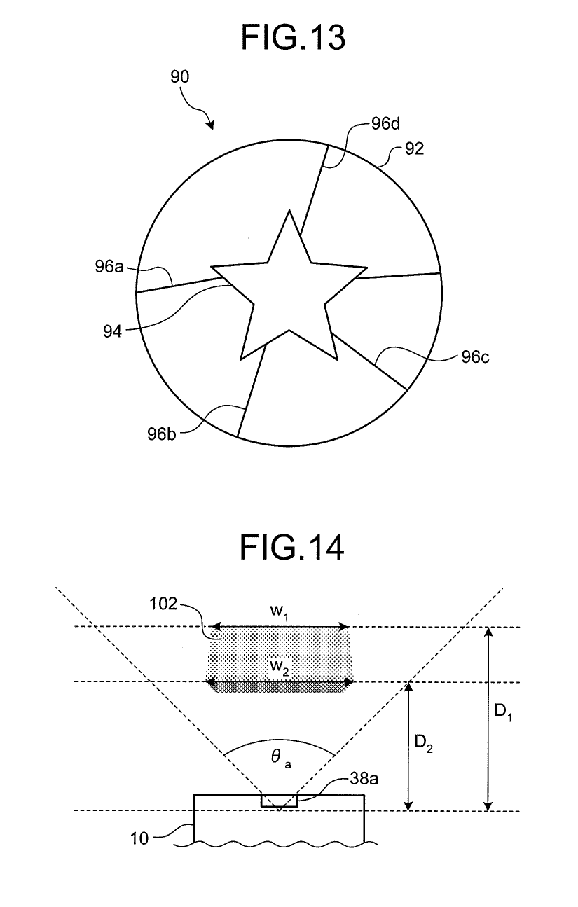

Another control of the mobile electronic device will be explained below with reference to FIG. 12 and FIG. 13. FIG. 12 is a flowchart illustrating another example of the operation of the mobile electronic device, and FIG. 13 is an explanatory diagram illustrating the irradiated plane to which an image is projected by the mobile electronic device. The flowchart illustrated in FIG. 12 is one example of operations in which the division lines including a specific shape are projected to and displayed on the target object (object arranged on the irradiated plane) of the image.

First, the control unit 22 of the mobile electronic device 10 displays an image of a circle to be projected on the display unit 32 as Step S200. In other words, the control unit 22 displays a shape coinciding with the outline of the target object on the display unit 32. Next, the control unit 22 determines the image to be projected as Step S202. In other words, the control unit 22 determines a shape to be cut out from the target object.

The image to be projected is determined by detecting the user operation. The image can be selected from any kind of images such as preset graphics, user-created images, and photographed images.

After the image to be projected is determined at Step S202, the control unit 22 projects the image and determines the size and the direction thereof as Step S204. In other words, the control unit 22 projects the image of which projection is determined at Step S202 to the target object by the projector 34, and determines the size of the image and the direction thereof with respect to the target object. The size and the direction are determined by detecting the user operation.

After the size and the direction thereof are determined at Step S204, the control unit 22 of the mobile electronic device 10 detects the number of divisions of the circle input by the operator as Step S206. After detecting the number of divisions at Step S206, the control unit 22 divides the circle corresponding to the target object based on the input number of divisions, as Step S208. Next, the control unit 22 calculates an area (total area) of the image to be projected as Step S210, subtracts an area for removal from the whole circle, and divides the rest of the circle by the number of divisions, as Step S212. In other words, the control unit 22 calculates an area per section of sections excluding the image of which projection is determined at Step S202. Thereafter, the control unit 22 calculates a difference between the areas of the respective sections before and after the clipping, as Step S214. In other words, the control unit 22 calculates a difference between the area in the state where the circle is divided at Step S208 and the area calculated at Step S212. After calculating the difference at Step S214, the control unit 22 adjusts locations of the division lines as Step S216. In other words, the control unit 22 adjusts the locations of the division lines so that the difference calculated at Step S214 is eliminated and each of the areas of the sections is the area of the section calculated at Step S212. The control unit 22 adjusts the locations of the division lines and equalizes the areas of the sections, and then determines the division lines.

After adjusting the locations of the division lines at Step S216, the control unit 22 measures a distance to the irradiated plane (projected plane) as Step S218. After measuring the distance to the irradiated plane at Step S218, the control unit 22 determines a size to be projected as Step S220. In other words, the control unit 22 generates image data so that the size of the circular scale becomes the set size on the irradiated plane, based on the distance to the irradiated plane and the size of the circular scale. When the size to be projected is determined at Step S220, the control unit 22 projects the created image to the irradiated plane as Step S222. In other words, the control unit 22 projects an image formed with the image of which projection is determined at Step S202 and with the division lines of which locations are adjusted, to the projected plane. After projecting the image at Step S222, the control unit 22 ends the process.

As explained above, the control unit 22 displays the image including the specific image (specific shape) and the division lines, so that, as illustrated in FIG. 13, the control unit 22 can create an image 90 formed with a circular scale 92, a specific image 94, and division lines 96a, 96b, 96c, and 96d, and project the created image. In this case, the specific image 94 is a star-shaped image. The division lines 96a, 96b, 96c, and 96d are differently spaced, respectively, however, the sections divided by the division lines and the visible outline of the specific image 94 have the same area as each other. Thus, when an image having a specific shape is also projected, the mobile electronic device 10 can divide the other portions at a certain size. This enables the user to cut the target object into a desired shape, and further divide the other areas uniformly or by a certain size.

It should be noted that a determination order to display a specific image and division lines is not limited to the embodiment. For example, the determination order may be such that after the location of the specific image is determined, the location of one division line is determined, and locations of the other division lines are determined based on the location of the one division line and the area. The mobile electronic device may combine the above mentioned controls. In other words, the specific image and the division lines may be displayed so as to prevent overlap with the obstacle.

In each of the examples according to the embodiment, the size of the image used to divide the target object and the size of the image to be projected are adjusted by the size of the target object, however, the adjustment is not limited thereto. The mobile electronic device 10 may project an image of an arbitrary size. In this case, it is preferable that the user can adjust the size after the projection.

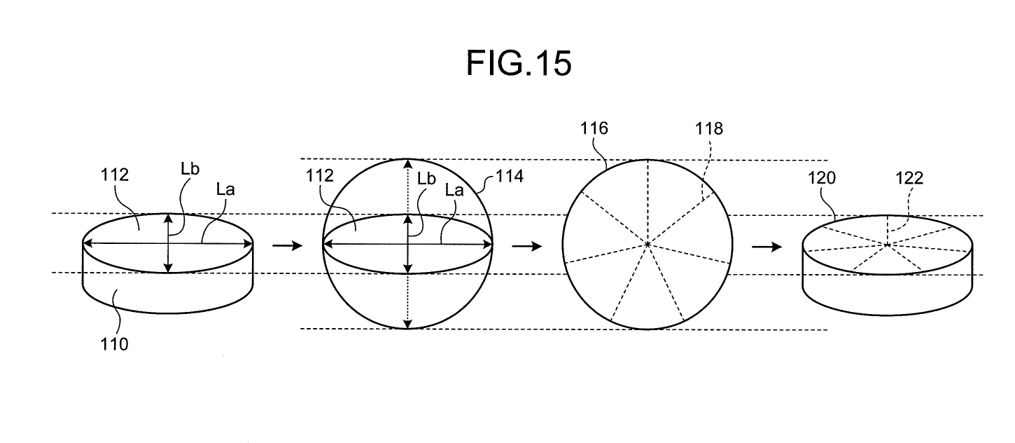

Each of the examples according to the embodiment has explained as a case where an image is basically projected from right above a desired face (top face) of the target object, however, the present invention is not limited thereto. In addition, when the desired face of the target object and the projection direction are not orthogonal to each other, it is preferable that an image to be projected or a projection area is corrected to project an image. This case will be explained below with reference to FIG. 14 and FIG. 15. FIG. 14 is an explanatory diagram illustrating a relationship between the mobile electronic device and a photographing target, and FIG. 15 is an explanatory diagram illustrating one example of a method of creating an image projected by the mobile electronic device.

First, the method of specifying a target object will be explained. The mobile electronic device 1 can specify a shape of a desired face of the target object based on the image detected by the camera 38 and the information about a focal length. Specifically, when the target object to be projected is a cuboid, as illustrated in FIG. 14, the mobile electronic device 10 photographs the target object by the camera 38 to capture an image through an image portion 38a. At this time, the camera 38 can capture an image having an angle of view θₐ. A target object 102 on the image photographed by the camera 38 has a side w₁ on its one side which is away from the mobile electronic device 10 and a side w₂ on the side of the mobile electronic device 10, whose lengths are different from each other. Specifically, the side w₂ is longer than the side w₁. Moreover, the camera 38 can calculate a distance D₁ to the side w₁ and a distance D₂ to side w₂ as focal length information at the time of capturing the image. The control unit 22 can detect an aspect ratio of the surface and each length of respective sides based on the lengths of the sides and the distances to the sides calculated in the above manner.

Then, when a target object to be projected is a cylinder (flat cylinder, a disk having a thickness), the mobile electronic device 10 specifies a desired face (top face) 112 of a target object 110 as illustrated in FIG. 15, and detects a major axis La and a minor axis Lb. Thereafter, the control unit 22 creates a circle 114 based on the major axis La of the face 112, and thereby enables to calculate a shape when the face 112 is viewed from the top face. In addition, similarly to the above, by detecting a focal length, the control unit 22 can calculate a distance to the target object 110. The present example is a case where it is preset and known that the face 112 is a circle.

Next, the mobile electronic device 10 creates an image to be projected. First, as illustrated in FIG. 15, the mobile electronic device 10 determines a diameter of the target object based on the information about the circle 114, and creates an image 116 including division lines 118. After creating the image 116, the mobile electronic device 10 converts the image 116 of the circle into an image 120 of an oblique in an opposite manner to the case where the image of the face 112 is converted into that of the circle 114. The dividing lines 118 are also converted into the dividing lines 122. The image 120 is an oblique having a major axis as La and a minor axis as Lb.

In this manner, the mobile electronic device 10 previously deforms the image 116 of the circle to the image 120 of the oblique for projection, so that the image of a desired shape can be projected to the desired face even if the desired face of the target object and its projection direction are not orthogonal to each other.

In other words, when the image is to be acquired, by acquiring the shape of the target object using a technology for trapezoidal correction, the mobile electronic device 10 can acquire the shape with an accurate shape and an exact area. When an image is to be projected, by performing a trapezoidal correction process based on an angle between the irradiated plane and the irradiation direction, the mobile electronic device 10 can project a desired image to the target object. As a method for trapezoidal correction process when an image is to be projected, as explained above, the trapezoidal correction process is performed on the image to be projected, so that by adjusting an area projected with the image and its projection method, the image (e.g., an image of a circle) of which target object is not distorted may be projected, while the image data remains as it is such as a circle even if the image of which target object is not distorted is projected.

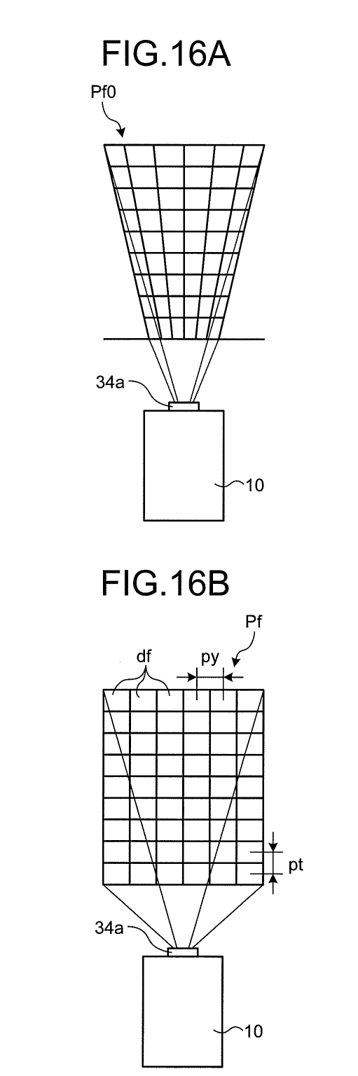

A case where an image (e.g., an image of a circle) whose target object is not distorted is projected by adjusting an area where an image is projected and a projection method will be explained below with reference to FIG. 16A and FIG. 16B. FIG. 16A and FIG. 16B are schematic diagrams each illustrating a state in which an image is projected by the mobile electronic device. When an angle between the mobile electronic device 10 and the irradiated plane, or the irradiation direction is not 90°, and only when light is irradiated from the projector 34 toward a mounting surface of the mobile electronic device 10, an image Pf0 projected as illustrated in FIG. 16A becomes a trapezoidal shape whose side close to the light emitting portion 34a of the mobile electronic device 10 is shorter than the other side.

Therefore, the mobile electronic device 10 adjusts an oscillation angle of a mirror forming the light emitting portion of the projector 34 according to a distance from the light emitting portion 34a of the projector 34 to the projected plane. This enables the trapezoidal shape to be corrected, and a rectangular image Pf is projected from the projector 34 as illustrated in FIG. 16B. The oscillation angle is controlled so as to be made smaller with an increase in a distance from the light emitting portion of the projector 34 to the projected plane.

In this case, in the mobile electronic device 10 as illustrated in FIG. 16B, the control unit 22 controls drawing by the projector 34 so that, of a plurality of pixels df constituting the image Pf formed by light irradiated from the light emitting portion 34a, spaces py each between adjacent pixels in a first direction are equal to each other and spaces pt each between adjacent pixels in a second direction orthogonal to the first direction are equal to each other. This enables to prevent distortion of an image to be projected and mismatch of the pixels, thus preventing decrease in image quality.

The first direction is, for example, a horizontal direction, which is a scanning direction of the projector 34. The second direction is, for example, a vertical direction, which is a direction (sub-scanning direction) orthogonal to the scanning direction of the projector 34. The vertical direction (vertical) is a direction parallel to an axis where a virtual optical axis, explained later, is projected onto the image Pf, and the horizontal direction (horizontal) is a direction orthogonal to the vertical direction. Here, the control unit 22 may further control so that the space py between the adjacent pixels in the first direction is made equal to the space pt between the adjacent pixels in the second direction.

When the shape of the image to be projected to the irradiated plane is corrected by the drawing in this manner, the mobile electronic device 10 preferably uses the projector using a laser light. If the projector uses the laser light, focusing is not needed, so that a more appropriate image can be projected. Particularly, in a scan type projector, light projected to form pixels of the image is a point light source, and, therefore, by changing a projection position, shape correction of the image can be easily achieved. However, any projector other than the scan type in which laser is provided as a light source can project an image subjected to the trapezoidal correction. Moreover, the mobile electronic device 10 preferably adjusts the size of pixels according to positions. Specifically, it is preferable to irradiate pixels in such a manner that each of the pixels is made smaller as the positions are farther and each of the pixels is made larger as the positions are closer.

In the embodiment, the distance to the irradiated plane is detected by the distance measuring sensor 40, however, as a sensor that detects a distance to the irradiated plane, various sensors can be used. For example, an autofocus function of the camera 38 for photographing the irradiated plane may also be used. Specifically, a focusing condition is detected by the autofocus function, and the focusing condition, for example, a distance to the irradiated plane is calculated from the location of a lens. A relationship between the distance to the irradiated plane and the focusing condition has only to be previously calculated and stored in the storage unit 24. As a method of determining whether an image is in focus, for example, an image is acquired at each focus position, and image analysis is performed on the acquired image, and then a condition capable of acquiring an image whose edges are sharpest and shading is clearest may be set as a focusing condition. In addition, the acceleration sensor 36 may be used to detect a distance to the irradiated plane. In this case, the distance to the irradiated plane can be detected by bringing, for example, the top face of the mobile electronic device 10 (housing 11) or the face provided with the light emitting portion 34a of the projector 34 into contact with the irradiated plane, setting this position as a reference position, and, thereafter, detecting an acceleration acting on the mobile electronic device 10 when the mobile electronic device 10 is moved so as to be separated from the irradiated plane, and calculating a movement distance from the acceleration.

The sensors may measure only a distance to the center of the irradiated plane, and detect a distance to the irradiated plane based on the result of measurement, however, distances to a plurality of points of the irradiated plane may be measured, and a distance to the irradiated plane may be detected based on the results of measurement of the points.

The embodiment is configured to form the distance measuring sensor with the transmitter and the receiver, so that the measurement wave transmitted (sent) from the transmitter is received by the receiver, however, the projector 34 may be used as the transmitter. In other words, the light irradiated from the projector 34 is set as the measurement wave, the light reflected by the target object may be received by the receiver. As the distance measuring sensor, any device is used if it can measure a distance to the target object, and, for example, a measuring device for measuring a distance to the target object using, for example, magnetism, sonic wave (sonar), or an electric field can also be used.

In the embodiment, the distance between the light emitting face of the projector and the irradiated plane is calculated based on the result of detection by the sensor, however, a reference position on the mobile electronic device side is not limited to the sensor. Therefore, a relative position between each of the sensors and the projector 34 and a relative position between each of the sensors and the top face of the housing are previously calculated, and a distance between each of the sensors and the irradiated plane and a distance between the top face of the housing and the irradiated plane are calculated, so that control may also be provided based on the calculated distances.

Here, in the embodiment, the size information about the object of an image is added to the data for the image, however, the user may manually input the size information. As for an image to be projected, in addition to the image stored in the storage unit and the image acquired through the Internet, an image photographed by the camera 38 may be used.

When an image is photographed by the camera 38, the size of an object may be detected at the time of photographing the image. In this case, a distance to the object is first calculated upon photographing by the camera 38. Here, the distance to the object may be calculated by using the distance measuring sensor 40 or may be calculated by using the autofocus function. Then, by performing image analysis on the photographed image, the object is extracted from the photographed image, a ratio of the object and a length of the object in the photographed image are calculated, a length of the object (actual size) is calculated based on the distance to the object upon photographing and based on the ratio of the object and the length of the object in the image, and information about the calculated length of the object may be added to the image. It should be noted that the object may be specified through the operation by the operator, and extracted.

In addition, the method of detecting the size of an object upon photographing may be used to calculate the size of an arbitrary object, and an image having the same size as that of the arbitrary object may be projected. Specifically, if the operator cannot input specific figures, it may be configured to indicate a desired projection size using an arbitrary object such as a finger, photograph the arbitrary object by the camera 38, calculate a size (actual size) indicated by the arbitrary object, and project the object in the size. This enables the object to be projected in a size desired by the operator even if the figures of the size desired by the operator are unknown.

### INDUSTRIAL APPLICABILITY

As explained above, the mobile electronic device according to the present invention is suitable for projecting a more serviceable and useful image.

### REFERENCE SIGNS LIST

10 mobile electronic device
11 housing
12 display
13 operation keys
14 dedicated key
15 microphone
16 receiver
22 control unit
24 storage unit
26 transmitter/receiver
26a antenna
28 operating unit
30 voice processor
32 display unit
34 projector
34a light emitting portion
36 acceleration sensor
38 camera
38a imaging portion
40 distance measuring sensor
40a transmitter
40b receiver

1. A mobile electronic device comprising:
an operating unit;
an image projector that projects an image toward a target object; and
a control unit that when information about the number of divisions of the target object is input from the operating unit,
causes the image projector to project an image used to divide the target object into the number of divisions.

2. The mobile electronic device according to claim 1, further comprising:
a distance detector that detects a distance from the image projector to an irradiated plane to which light emitted by the image projector is irradiated, wherein
the control unit performs image processing on an image to be projected by the image projector, and controls an operation of the image projector, and wherein
when the information for the number of divisions is input from the operating unit,
the control unit generates an image for division, detects a size of the irradiated plane from the distance detected by the distance detector, determines the size of the image to be projected from the image projector based on the detected size of the irradiated plane, and causes the image projector to project the image divided by the number of divisions to the irradiated plane.

3. The mobile electronic device according to claim 2, further comprising:
an imaging unit that photographs an image of the irradiated plane; and
an image analyzer that analyzes the image photographed by the imaging unit and extracts the target object, wherein
the control unit determines a layout of division lines based on a configuration of the target object detected based on a result of detection by the image analyzer.

4. The mobile electronic device according to claim 3, wherein the control unit determines a shape of the division lines based on the configuration of the target object.

5. The mobile electronic device according to claim 3, wherein the control unit determines a layout inhibited area of the division lines from the configuration of the target object, and arranges the division lines at positions that do not overlap the layout inhibited area.

6. The mobile electronic device according to claim 2 further comprising:
an imaging unit that photographs an image of the irradiated plane; and
an image analyzer that analyzes the image photographed by the imaging unit and extracts the target object, wherein
the control unit calculates a size of the target object extracted by the image analyzer based on the distance between the irradiated plane and the image projector detected by the distance detector, and determines the size of the image to be projected from the image projector further based on the size of the target object.

7. The mobile electronic device according to claim 1, further comprising:
an angle detector that detects an angle between an irradiation direction of the light from the image projector and the irradiated plane, wherein
the control unit corrects the image to be projected or an area where an image is projected by the image projector so that the image to be projected to the target object becomes the same shape as that of image data, based on the angle detected by the angle detector.

8. The mobile electronic device according to claim 1, wherein
the control unit generates an image based on setting in which the irradiation direction of light from the image projector and the irradiated plane are orthogonal to each other.

9. The mobile electronic device according to claim 2, wherein the control unit adjusts the size of the image so that the target object is projected to the irradiated plane in actual size, based on the detected size of the irradiated plane and the size of the target object.

10. The mobile electronic device according to claim 9, wherein the image for division is a ruler, a protractor, or any device that includes scale marks thereof.

11. The mobile electronic device according to claim 2, wherein the distance detector is a distance measuring sensor.

12. The mobile electronic device according to claim 11, wherein
the distance measuring sensor includes a light-emitting element and a light-receiving element, and receives light emitted from the light-emitting element and reflected on the irradiated plane by the light-receiving element, to detect a distance between the image projector and the irradiated plane.

13. The mobile electronic device according to claim 11, wherein the distance measuring sensor includes a light-receiving element, and receives light irradiated from the image projector and reflected on the irradiated plane by the light-receiving element, to detect a distance between the image projector and the irradiated plane.

14. The mobile electronic device according to claim 11, wherein the distance measuring sensor receives infrared rays, to detect a distance between the image projector and the irradiated plane.

15. The mobile electronic device according to claim 2, further comprising:
a photographing system having an autofocus function, wherein
the distance detector detects a distance using the autofocus function of the photographing system.

16. A mobile electronic device comprising:
an operating unit;
a display unit;
an imaging unit; and
a control unit that when information about the number of divisions to divide a target object photographed by the imaging unit is input from the operating unit,
controls the display unit so that an image used to divide the target object into the number of divisions and an image of the target object are displayed in a superimposed manner.

17. The mobile electronic device according to claim 16, further comprising:
an image analyzer that analyzes an image photographed by the imaging unit and extracts the target object, wherein
when information for the number of divisions is input to the operating unit,
the control unit determines a location of a division line, generates an image divided into the number of divisions, and displays the image divided into the number of divisions superimposed on an image of the target object detected based on a result of detection by the image analyzer, on the display unit.
